(19) United States
(12) Patent Application Publication
(10) Pub. No.: US 2014/0226116 A1
(43) Pub. Date: Aug. 14, 2014

(54) LIQUID CRYSTAL DISPLAY AND METHOD FOR PRODUCING LIQUID CRYSTAL DISPLAY

(71) Applicant: JSR CORPORATION, Tokyo (JP)

(72) Inventors: Eiji HAYASHI, Tokyo (JP); Kouji KASHISHITA, Tokyo (JP)

(73) Assignee: JSR CORPORATION, Tokyo (JP)

(21) Appl. No.: 14/178,593

(22) Filed: Feb. 12, 2014

(30) Foreign Application Priority Data
Feb. 13, 2013 (JP) 2013-025058

(51) Int. Cl. G02F 1/1337

(52) U.S. Cl. CPC G02F 1/133723
USPC 349/127; 445/24

(57) ABSTRACT

A liquid crystal display includes a liquid crystal layer and a liquid crystal alignment film. The liquid crystal layer includes a liquid crystal composition that includes a cyclohexane compound represented by a formula (1). The liquid crystal alignment film is provided using a liquid crystal aligning agent that includes a polymer which is a polyamic acid, a polyimide, a polyamic ester, or a combination thereof. R¹¹ and R¹² are each independently a monovalent chain hydrocarbon group, or a group obtained by substituting —CH₂— included in the chain hydrocarbon group with —O—, —CO—, or —COO—. At least one hydrogen atom included in R¹¹ and R¹² is optionally substituted with a halogen atom or a cyano group. Q¹ is a divalent group represented by a formula (1-1), a divalent group represented by a formula (1-2), or a divalent group represented by a formula (1-3).

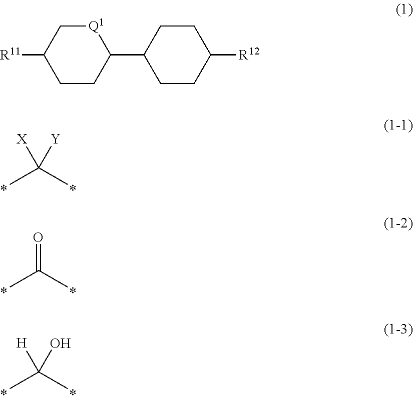

### CROSS-REFERENCE TO RELATED APPLICATIONS

The present application claims priority under 35 U.S.C. §119 to Japanese Patent Application No. 2013-025058, filed Feb. 13, 2013. The contents of this application are incorporated herein by reference in their entirety.

### BACKGROUND OF THE INVENTION

1. Field of the Invention

The invention relates to a liquid crystal display and a method for producing a liquid crystal display.

2. Discussion of the Background

Various types of liquid crystal displays that differ in the electrode structure, the properties of liquid crystal molecules, and the like have been developed. For example, a TN-mode liquid crystal display, an STN-mode liquid crystal display, a vertical alignment (VA)-mode liquid crystal display, an in-plane switching (IPS)-mode liquid crystal display, an FFS-mode liquid crystal display, an optically compensated bend (OCB)-mode liquid crystal display, and the like have been known. These liquid crystal displays include a liquid crystal alignment film for aligning the liquid crystal molecules.

A liquid crystal composition that includes a specific cyclohexane compound has been proposed aimed at improving the response speed of a liquid crystal display (see WO2012/011375).

### SUMMARY OF THE INVENTION

According to one aspect of the present invention, a liquid crystal display includes a liquid crystal layer and a liquid crystal alignment film. The liquid crystal layer includes a liquid crystal composition that includes a cyclohexane compound represented by a formula (1). The liquid crystal alignment film is provided using a liquid crystal aligning agent that includes a polymer which is a polyamic acid, a polyimide, a polyamic ester, or a combination thereof.

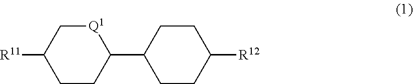

R¹¹ and R¹² are each independently a monovalent chain hydrocarbon group, or a group obtained by substituting —CH₂— included in the chain hydrocarbon group with —O—, —CO—, or —COO—. At least one hydrogen atom included in R¹¹ and R¹² is optionally substituted with a halogen atom or a cyano group. Q¹ is a divalent group represented by a formula (1-1), a divalent group represented by a formula (1-2), or a divalent group represented by a formula (1-3).

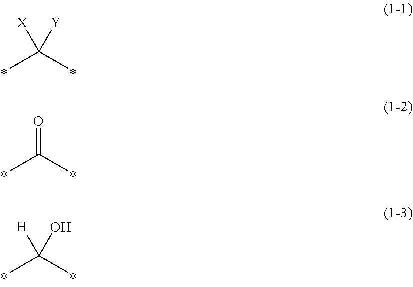

X is a hydrogen atom or a halogen atom. Y is a halogen atom. X and Y are either identical or different when X is a halogen atom. * is a bonding position.

According to another aspect of the present invention, a method for producing a liquid crystal display includes applying a liquid crystal aligning agent to a surface of each of a pair of substrates. The liquid crystal aligning agent includes a polymer which is a polyamic acid, a polyimide, a polyamic ester, or a combination thereof. The liquid crystal aligning agent is heated to form a film. The pair of substrates is disposed so that the films formed on the pair of substrates face each other through a liquid crystal layer to provide a liquid crystal cell. The liquid crystal layer includes a liquid crystal composition which includes a cyclohexane compound represented by a formula (1).

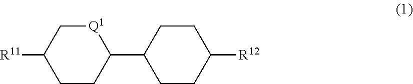

R¹¹ and R¹² are each independently a monovalent chain hydrocarbon group, or a group obtained by substituting —CH₂— included in the chain hydrocarbon group with —O—, —CO—, or —COO—. At least one hydrogen atom included in R¹¹ and R¹² is optionally substituted with a halogen atom or a cyano group. Q¹ is a divalent group represented by a formula (1-1), a divalent group represented by a formula (1-2), or a divalent group represented by a formula (1-3).

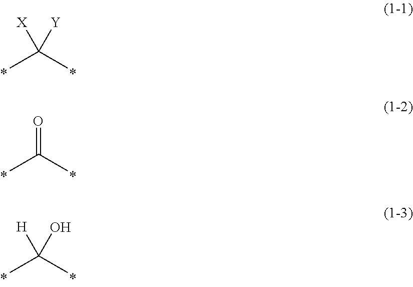

X is a hydrogen atom or a halogen atom. Y is a halogen atom. X and Y are either identical or different when X is a halogen atom. * is a bonding position.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a schematic configuration diagram illustrating an FFS-mode liquid crystal display.

FIGS. 2A and 2B are schematic plan views (top view and partial enlarged view) illustrating a top electrode.

### DESCRIPTION OF THE EMBODIMENTS

The embodiments will now be described with reference to the accompanying drawings, wherein like reference numerals designate corresponding or identical elements throughout the various drawings.

A liquid crystal display according to exemplary embodiments of the invention is described below. A liquid crystal display according to one embodiment of the invention includes a liquid crystal layer that is formed of a liquid crystal composition, and a liquid crystal alignment film that is formed using a liquid crystal aligning agent that includes a polymer component. The liquid crystal layer is disposed between a pair of substrates, and the liquid crystal alignment film is formed on each of the pair of substrates, and disposed adjacent to the liquid crystal layer.

### Liquid Crystal Layer

### Liquid Crystal Composition

The liquid crystal composition includes the cyclohexane compound represented by the formula (1). R¹¹ and R¹² in the formula (1) are independently a monovalent chain-like hydrocarbon group, or a group obtained by substituting —CH₂— included in the chain-like hydrocarbon group with —O—, —CO—, or —COO—.

The term “hydrocarbon group” used herein includes a chain-like hydrocarbon group, an alicyclic hydrocarbon group, and an aromatic hydrocarbon group. The term “chain-like hydrocarbon group” used herein refers to a linear hydrocarbon group and a branched hydrocarbon group that do not include a cyclic structure in the main chain, and include only a chain-like structure. The term “chain-like hydrocarbon group” used herein includes a saturated hydrocarbon group and an unsaturated hydrocarbon group. The term “alicyclic hydrocarbon group” used herein refers to a hydrocarbon group that includes only an alicyclic hydrocarbon structure as a cyclic structure, and does not include an aromatic ring structure. Note that the alicyclic hydrocarbon group need not necessarily include only an alicyclic hydrocarbon structure, but may also include a chain-like structure. The term “aromatic hydrocarbon group” used herein refers to a hydrocarbon group that includes an aromatic ring structure as a cyclic structure. Note that the aromatic hydrocarbon group need not necessarily include only an aromatic ring structure, but may also include a chain structure or an alicyclic hydrocarbon structure.

Examples of the chain-like hydrocarbon group represented by R¹¹ and R¹² include a methyl group, an ethyl group, a propyl group, a butyl group, a pentyl group, a hexyl group, a heptyl group, an octyl group, a nonyl group, a decyl group, a vinyl group, an allyl group, a butenyl group, an ethynyl group, a propynyl group, a butyryl group, an isopropyl group, a 1-methylpropyl group, a 2-methylpropyl group, a 2-butylmethyl group, a 3-methylbutyl group, a 2-methylpentyl group, a 3-methylpentyl group, a 2-ethylhexyl group, a 2-propylpentyl group, a 1-methylpentyl group, and the like.

Examples of the group represented by R¹¹ and R¹² that is obtained by substituting —CH₂— of the chain-like hydrocarbon group with —O—, include RO—*, ROCO—*, RCOO—* (wherein R is a chain-like hydrocarbon group, and “*” is the bonding position), chain-like hydrocarbon groups wherein —O—, —CO—, or —COO— is interposed between a carbon-carbon bond, and the like. Specific examples of these chain-like hydrocarbon groups include a methoxymethyl group, an ethoxymethyl group, a propoxymethyl group, a butoxymethyl group, a methoxyethyl group, an ethoxyethyl group, and the like.

Some or all of the hydrogen atoms included in R¹¹ and R¹² are optionally substituted with a halogen atom or a cyano group. Specific examples of the chain-like hydrocarbon group represented by R¹¹ and R¹² in which some or all of the hydrogen atoms are substituted with a halogen atom or a cyano group include a perfluoromethyl group, a perfluoroethyl group, a perfluoropropyl group, a monofluoromethyl group, a difluoromethyl group, a trifluoromethyl group, a perfluorovinyl group, a perfluoroallyl group, and the like.

R¹¹ and R¹² are preferably an unsubstituted chain-like hydrocarbon group, more preferably an alkyl group or an alkenyl group, and still more preferably an alkyl group. The number of carbon atoms of R¹¹ and R¹² is preferably 1 to 20, and more preferably 1 to 10. Note that the compound represented by the formula (1) may be present as a mixture of a plurality of stereoisomers. When the compound represented by the formula (1) may be present in the form of a cis/trans isomer, a trans isomer is preferable.

Specific examples of the compound represented by the formula (1) include compounds represented by the following formulas (1-1) to (1-5), and the like. Note that the compound represented by the formula (1) is not limited thereto. Only one type of the compound represented by the formula (1) may be used alone, or two or more types of the compound represented by the formula (1) may be used in combination.

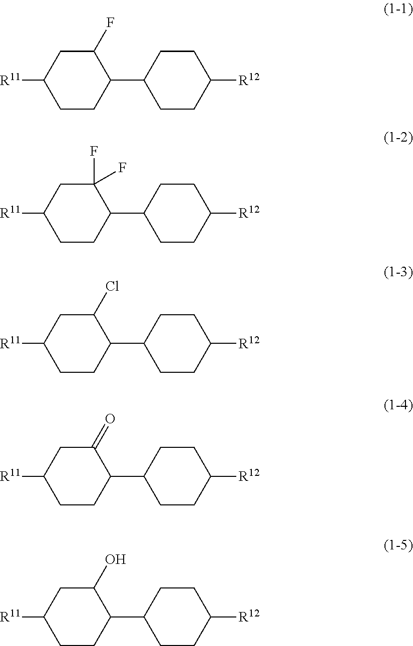

wherein R¹¹ and R¹² are the same as defined for the formula (1).

The liquid crystal composition may include an additional liquid crystalline compound other than the compound represented by the formula (1). Examples of the additional liquid crystalline compound include a nematic liquid crystal and a smectic liquid crystal. It is preferable to use a nematic liquid crystal. For example, a Schiff base-based liquid crystal, an azoxy-based liquid crystal, a biphenyl-based liquid crystal, a phenylcyclohexane-based liquid crystal, an ester-based liquid crystal, a terphenyl-based liquid crystal, a biphenylcyclohexane-based liquid crystal, a pyrimidine-based liquid crystal, a dioxane-based liquid crystal, a bicyclooctane-based liquid crystal, a cubane-based liquid crystal, or the like may be used.

The additional liquid crystalline compound may be used corresponding to the drive mode of the liquid crystal display. For example, it is preferable to use at least one compound selected from the group (first group) consisting of a compound represented by the following formula (2), a compound represented by the following formula (3), and a compound represented by the following formula (4) when producing an FFS, IPS, or TN-mode liquid crystal display. The response speed is improved by utilizing the liquid crystal composition that includes such a compound.

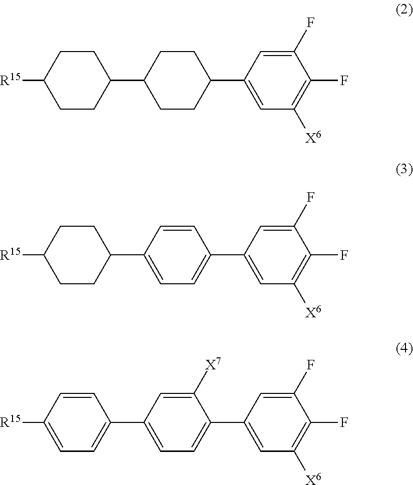

wherein R¹⁵ is an alkyl group, and X⁶ and X⁷ are independently a hydrogen atom or a fluorine atom.

The number of carbon atoms of R¹⁵ in the formulas (2), (3), and (4) is preferably 1 to 20, and more preferably 1 to 10. The alkyl group represented by R¹⁵ may be a linear or branched alkyl group, but is preferably a linear alkyl group. The liquid crystal composition may include only one compound among the compound represented by the formula (2), the compound represented by the formula (3), and the compound represented by the formula (4) as the additional liquid crystalline compound, or may include two or three compounds among the compound represented by the formula (2), the compound represented by the formula (3), and the compound represented by the formula (4) as the additional liquid crystalline compound. The liquid crystal composition may include a plurality of the same type of compounds.

It is preferable to use at least one compound selected from the group (second group) consisting of a compound represented by the following formula (6), a compound represented by the following formula (7), and a compound represented by the following formula (8) when producing an FFS, IPS, or VA-mode liquid crystal display. The response speed is improved by utilizing the liquid crystal composition that includes such a compound. A positive-type liquid crystal and a negative-type liquid crystal may be used for an FFS-mode liquid crystal display and an IPS-mode liquid crystal display. Therefore, one or more compounds selected from the first group or one or more compounds selected from the second group may be used as the additional liquid crystalline compound when producing an FFS or IPS-mode liquid crystal display.

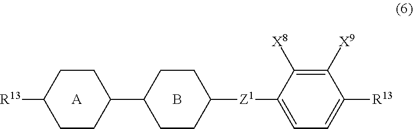

wherein R¹³ and R¹⁴ are independently an alkyl group having 1 to 12 carbon atoms, an alkoxy group having 1 to 12 carbon atoms, an alkenyl group having 2 to 12 carbon atoms, or an alkenyloxy group having 2 to 11 carbon atoms wherein an arbitrary hydrogen atom is optionally substituted with a fluorine atom, A and B are independently a 1,4-cyclohexylene group or a 1,4-phenylene group, X⁸ and X⁹ are independently a fluorine atom or a chlorine atom, and Z¹ is a methyleneoxy group, a carbonyloxy group, an ethylene group, or a single bond.

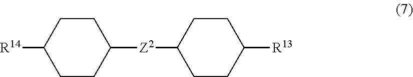

wherein Z² is a single bond or an ethylene group, and R¹³ and R¹⁴ are the same as defined for the formula (6).

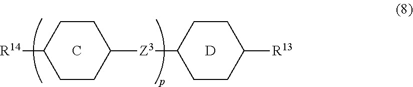

wherein C and D are independently a 1,4-cyclohexylene group, a 1,4-phenylene group, a 2-fluoro-1,4-phenylene group, or a 3-fluoro-1,4-phenylene group, p is an integer from 1 to 3, provided that D is a 1,4-phenylene group when p is 1, Z³ is a single bond, an ethylene group, a methyleneoxy group, or a carbonyloxy group, provided that a plurality of C and a plurality of Z³ are respectively either identical or different when p is 2 or 3, and R¹³ and R¹⁴ are the same as defined for the formula (6).

R¹³ and R¹⁴ in the formulas (6), (7), and (8) may be linear or branched, but are preferably linear. R¹³ and R¹⁴ are preferably an alkyl group or an alkoxy group. The liquid crystal composition may include only one compound among the compound represented by the formula (6), the compound represented by the formula (7), and the compound represented by the formula (8) as the additional liquid crystalline compound, or may include two or three compounds among the compound represented by the formula (6), the compound represented by the formula (7), and the compound represented by the formula (8) as the additional liquid crystalline compound. The liquid crystal composition may include a plurality of the same type of compounds.

The liquid crystal composition preferably includes the compound represented by the formula (1) in an amount of 0.1 to 80 parts by weight, more preferably 1 to 65 parts by weight, and still more preferably 3 to 50 parts by weight, based on 100 parts by weight (total amount) of the liquid crystal composition.

When using one or more compounds selected from the first group or one or more compounds selected from the second group as the additional liquid crystalline compound, the liquid crystal composition preferably includes the additional liquid crystalline compound in an amount (total amount) of 20 to 99.9 parts by weight, more preferably 35 to 99 parts by weight, and still more preferably 50 to 97 parts by weight, based on 100 parts by weight (total amount) of the liquid crystal composition.

The liquid crystal composition may optionally include an additional component other than the compound represented by the formula (1) and the additional liquid crystalline compound. Examples of the additional component include a chiral agent (e.g., “C-15” and “CB-15” manufactured by Merck), a ferroelectric liquid crystal (e.g., p-decyloxybenzilidene-p-amino-2-methylbutyl cinnamate), an antioxidant, a UV absorber, a pigment, an antifoaming agent, and the like.

The liquid crystal composition is prepared by mixing the compound represented by the formula (1), the additional liquid crystalline compound, and the optional additional component. The components may be mixed at room temperature, or may be mixed while increasing the temperature. Each component may be dissolved in an organic solvent (e.g., acetone, chloroform, or methanol), and the solvent may be removed by distillation or the like.

### Liquid Crystal Alignment Film

The liquid crystal aligning agent includes the polymer (A) as the polymer component, the polymer (A) being at least one polymer selected from the group consisting of a polyamic acid, a polyimide, and a polyamic ester. The liquid crystal aligning agent is preferably a liquid composition in which the polymer (A) is dispersed or dissolved in a solvent.

### Polymer (A)

### Polyamic Acid

The polyamic acid used as the polymer (A) may be obtained by reacting a tetracarboxylic dianhydride with a diamine.

### Tetracarboxylic Dianhydride

Examples of the tetracarboxylic dianhydride used to synthesize the polyamic acid include aliphatic tetracarboxylic dianhydrides, alicyclic tetracarboxylic dianhydrides, aromatic tetracarboxylic dianhydrides, and the like. Specific examples of the aliphatic tetracarboxylic dianhydrides include 1,2,3,4-butanetetracarboxylic dianhydride. Specific examples of the alicyclic tetracarboxylic dianhydrides include 1,2,3,4-cyclobutanetetracarboxylic dianhydride, 2,3,5-tricarboxycyclopentylacetic dianhydride, 1,3,3a,4,5,9 b-hexahydro-5-(tetrahydro-2,5-dioxo-3-furanyl)-naphtho[1,2-c]furan-1,3-dione, 1,3,3a,4,5,9 b-hexahydro-8-methyl-5-(tetrahydro-2,5-dioxo-3-furanyl)-naphtho[1,2-c]furan-1,3-dione, 3-oxabicyclo[3.2.1]octane-2,4-dione-6-spiro-3′-(tetrahydrofuran-2′,5′-dione), 5-(2,5-dioxotetrahydro-3-furanyl)-3-methyl-3-cyclohexene-1,2-dicarboxylic anhydride, 3,5,6-tricarboxy-2-carboxymethylnorbornane-2:3,5:6-dianhydride, 4,9-dioxatricyclo[5.3.1.0^{2′6}]undecane-3,5,8,10-tetraone, cyclohexanetetracarboxylic dianhydride, a compound represented by the following formula (t−1), and the like.

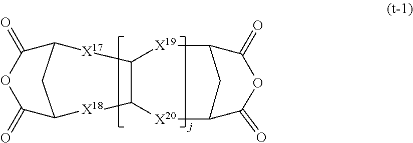

wherein X¹⁷, X¹⁸, X¹⁹, and X²° are independently a single bond or a methylene group, and j is an integer from 1 to 3. Specific examples of the aromatic tetracarboxylic dianhydrides include pyromellitic dianhydride and the like. The tetracarboxylic dianhydrides disclosed in Japanese Patent Application Publication (KOKAI) No. 2010-97188 may also be used. These tetracarboxylic dianhydrides may be used either alone or in combination.

Examples of the compound represented by the formula (t−1) include bicyclo[3.3.0]octane-2,4,6,8-tetracarboxylic dianhydride, bicyclo[4.3.0]nonane-2,4,7,9-tetracarboxylic dianhydride, bicyclo[4.4.0]decane-2,4,7,9-tetracarboxylic dianhydride, bicyclo[4.4.0]decane-2,4,8,10-tetracarboxylic dianhydride, tricyclo[6.3.0.0<2,6>]undecane-3,5,9,11-tetracarboxylic dianhydride, and the like. Among these, bicyclo[3.3.0]octane-2,4,6,8-tetracarboxylic dianhydride is preferable from the viewpoint of the stability of liquid crystal alignment.

It is preferable to use at least one compound selected from the group consisting of the compound represented by the formula (t−1), 1,2,3,4-cyclobutanetetracarboxylic dianhydride, and pyromellitic dianhydride (hereinafter may be referred to as “specific tetracarboxylic dianhydride”) as the tetracarboxylic dianhydride used to synthesize the polyamic acid. The specific tetracarboxylic dianhydride is preferably used in a ratio of 10 mol % or more, and more preferably 20 to 100 mol %, based on the total amount of the tetracarboxylic dianhydride used to synthesize the polyamic acid.

### Diamine

A known diamine may be used to synthesize the polyamic acid. It is preferable to use at least one diamine selected from the group consisting of a compound represented by the following formula (d−1), a compound represented by the following formula (d-2), a compound represented by the following formula (d-3), and a compound represented by the following formula (d-4) (hereinafter may be referred to as “specific diamine”).

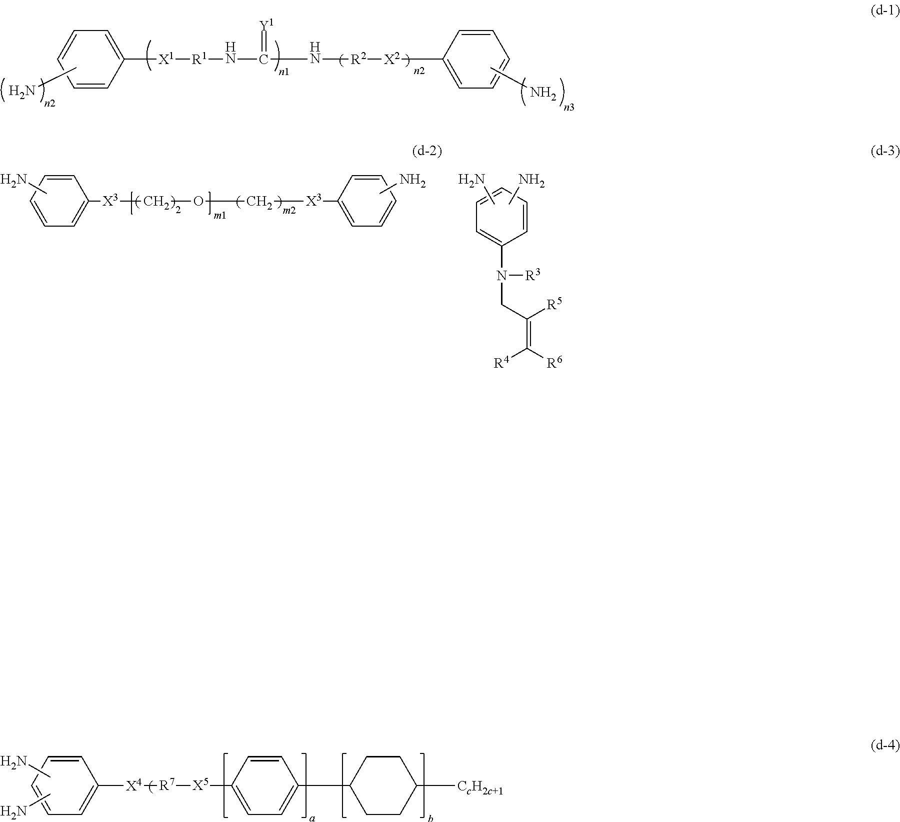

wherein X¹ and X² are independently a single bond, —O—, —S—, —OCO—, or —COO—, Y¹ is an oxygen atom or a sulfur atom, R¹ and R² are independently an alkanediyl group having 1 to 3 carbon atoms, n1 is 0 or 1, n2 and n3 are integers that satisfy “n2+n3=2” when n1 is 0, and are 1 when n1 is 1, X³ are a single bond, —O—, or —S—, provided that X³ are either identical or different, m1 is an integer from 0 to 3, m2 is an integer from 1 to 12 when m1 is 0, and is 2 when m1 is an integer from 1 to 3, R³ is a linear or branched monovalent hydrocarbon group having 1 to 12 carbon atoms, R⁴ is a hydrogen atom or a linear or branched monovalent hydrocarbon group having 1 to 12 carbon atoms, R⁵ and R⁶ are independently a hydrogen atom or a methyl group, X⁴ and X⁵ are independently a single bond, —O—, —COO—, or —OCO—, R⁷ is an alkanediyl group having 1 to 3 carbon atoms, a is 0 or 1, b is an integer from 0 to 2, c is an integer from 1 to 20, and k is 0 or 1, provided that a case where a=b=0 is excluded.
Compound Represented by Formula (d−1)

Examples of the alkanediyl group having 1 to 3 carbon atoms represented by R¹ and R² in the formula (d−1) include a methylene group, an ethylene group, a propane-1,2-diyl group, a propane-1,3-diyl group, a propane-2,3-diyl group, and the like. Among these, a methylene group, an ethylene group, and a propane-1,3-diyl group are preferable.

X¹ and X² are a single bond, —O—, —S—, —OCO—, or —COO—. X¹ and X² are either identical or different. X¹ and X² are preferably a single bond, —O—, or —S—.

Y¹ is an oxygen atom or a sulfur atom. Y¹ is preferably an oxygen atom.

The two primary amino groups included in the compound represented by the formula (d−1) may be bonded to an identical benzene ring, or may respectively be bonded to different benzene rings when n1=0. The two primary amino groups are respectively bonded to different benzene rings when n1=1.

The bonding position of the primary amino group on the benzene ring is not particularly limited. For example, when one primary amino group is bonded to a benzene ring, the bonding position of the primary amino group may be the 2-position, the 3-position, or the 4-position (preferably the 3-position or the 4-position, and more preferably the 4-position) relative to another group. When two primary amino groups are bonded to a benzene ring, the bonding positions of the two primary amino groups may be the 2,4-positions, the 2,5-positions, or the like (preferably the 2,4-positions) relative to another group.

A hydrogen atom on the benzene ring to which the primary amino group is bonded may be substituted with a monovalent hydrocarbon group having 1 to 10 carbon atoms, a monovalent group obtained by substituting at least one hydrogen atom of the hydrocarbon group with a fluorine atom, or a fluorine atom. Examples of the monovalent hydrocarbon group include an alkyl group having 1 to 10 carbon atoms, an alkenyl group having 2 to 10 carbon atoms, a cycloalkyl group having 3 to 10 carbon atoms, an aryl group having 5 to 10 carbon atoms (e.g., phenyl group and tolyl group), an aralkyl group having 5 to 10 carbon atoms (e.g., benzyl group), and the like.

Specific examples of a preferable compound represented by the formula (d−1) wherein n1=0 include 4,4′-diaminodiphenylamine, 2,4-diaminodiphenylamine, and the like. Specific examples of a preferable compound represented by the formula (d−1) wherein n1=1 include 1,3-bis(4-aminobenzyl)urea, 1,3-bis(4-aminophenethyl)urea, 1,3-bis(3-aminobenzyl)urea, 1-(4-aminobenzyl)-3-(4-aminophenethyl)urea, 1,3-bis(2-(4-aminophenoxy)ethyl)urea, 1,3-bis(3-(4-aminophenoxy)propyl)urea, 1,3-bis(4-aminobenzyl)thiourea, 1,3-bis(2-aminobenzyl)urea, 1,3-bis(2-aminophenethyl)urea, 1,3-bis(2-(2-aminobenzoyloxy)ethyl)urea, 1,3-bis(3-(2-aminobenzoyloxy)propyl)urea, and the like. These compounds may be used either alone or in combination as the compound represented by the formula (d−1).

Compound represented by formula (d-2)

X³ in the formula (d-2) are a single bond, —O—, or —S—, and preferably a single bond or —O—. The two X³ in the molecule may be either identical or different.

m2 is an integer from 1 to 12 when m1=0. m2 is preferably an integer from 1 to 10, and more preferably an integer from 1 to 8 when m1=0 from the viewpoint of ensuring that the resulting polymer exhibits excellent heat resistance. It is preferable that m1=0 from the viewpoint of improving rubbing resistance while maintaining an excellent liquid crystal alignment capability. It is preferable that m1 be an integer from 1 to 3 from the viewpoint of reducing the pretilt angle of the liquid crystal molecules.

The bonding position of each primary amino group on the benzene ring is not particularly limited. The bonding position of each primary amino group is preferably the 3-position or the 4-position (more preferably the 4-position) relative to another group. A hydrogen atom on the benzene ring to which the primary amino group is bonded may be substituted with a monovalent hydrocarbon group having 1 to 10 carbon atoms, a monovalent group obtained by substituting at least one hydrogen atom of the hydrocarbon group with a fluorine atom, or a fluorine atom.

Specific examples of a preferable compound represented by the formula (d-2) include bis(4-aminophenoxy)methane, bis(4-aminophenoxy)ethane, bis(4-aminophenoxy)propane, bis(4-aminophenoxy)butane, bis(4-aminophenoxy)pentane, bis(4-aminophenoxy)hexane, bis(4-aminophenoxy)heptane, bis(4-aminophenoxy)octane, bis(4-aminophenoxy)nonane, bis(4-aminophenoxy)decane, bis(4-aminophenyl)methane, bis(4-aminophenyl)ethane, bis(4-aminophenyl)propane, bis(4-aminophenyl)butane, bis(4-aminophenyl)pentane, bis(4-aminophenyl)hexane, bis(4-aminophenyl)heptane, bis(4-aminophenyl)octane, bis(4-aminophenyl)nonane, bis(4-aminophenyl)decane, 1,3-bis(4-aminophenylsulfanyl)propane, 1,4-bis(4-aminophenylsulfanyl)butane, and the like. These compounds may be used either alone or in combination as the compound represented by the formula (d-2).

Compound Represented by Formula (d-3)

R³ in the formula (d-3) is a linear or branched monovalent hydrocarbon group having 1 to 12 carbon atoms. Specific examples of the linear or branched monovalent hydrocarbon group having 1 to 12 carbon atoms include alkyl groups such as a methyl group, an ethyl group, a propyl group, an isopropyl group, a butyl group, an isobutyl group, a t-butyl group, a pentyl group, a hexyl group, an octyl group, and a decyl group; alkenyl groups such as a vinyl group and an allyl group; cycloalkyl groups such as a cyclopentyl group and a cyclohexyl group; aryl groups such as a phenyl group and a tolyl group; aralkyl group such as a benzyl group; and the like. The number of carbon atoms of R³ is preferably 1 to 6, and more preferably 1 to 3. R³ is preferably a chain-like hydrocarbon group, more preferably a chain-like hydrocarbon group that includes a carbon-carbon double bond, and still more preferably an alkenyl group.

R⁴ is a hydrogen atom or a linear or branched monovalent hydrocarbon group having 1 to 12 carbon atoms. Examples of the hydrocarbon group include a chain-like hydrocarbon group having 1 to 12 carbon atoms, an alicyclic hydrocarbon group having 3 to 12 carbon atoms, and an aromatic hydrocarbon group having 5 to 12 carbon atoms. Specific examples of the hydrocarbon group include the groups mentioned above in connection with R³, and the like. A chain-like hydrocarbon group is preferable as the hydrocarbon group. R⁴ is preferably a hydrogen atom or a hydrocarbon group having 1 to 6 carbon atoms, more preferably a hydrogen atom or a hydrocarbon group having 1 to 3 carbon atoms, and still more preferably a hydrogen atom.

R⁵ and R⁶ are independently a hydrogen atom or a methyl group. It is preferable that both R⁵ and R⁶ be hydrogen atoms.

The bonding positions of the two primary amino groups included in the diaminophenyl group in the formula (d-3) are not particularly limited, but are preferably the 2,4-positions or the 2,5-positions (more preferably the 2,4-positions) relative to the nitrogen atom bonded to the benzene ring. A hydrogen atom on the benzene ring to which the primary amino group is bonded may be substituted with a monovalent hydrocarbon group having 1 to 10 carbon atoms, a monovalent group obtained by substituting at least one hydrogen atom of the hydrocarbon group with a fluorine atom, or a fluorine atom.

Specific examples of a preferable compound represented by the formula (d-3) include 2,4-diamino-N,N-diallylaniline, 2,5-diamino-N,N-diallylaniline, the compounds respectively represented by the following formulas (d-3-1) to (d-3-3), and the like. Among these, 2,4-diamino-N,N-diallylaniline or 2,5-diamino-N,N-diallylaniline may preferably be used. These compounds may be used either alone or in combination as the compound represented by the formula (d-3).

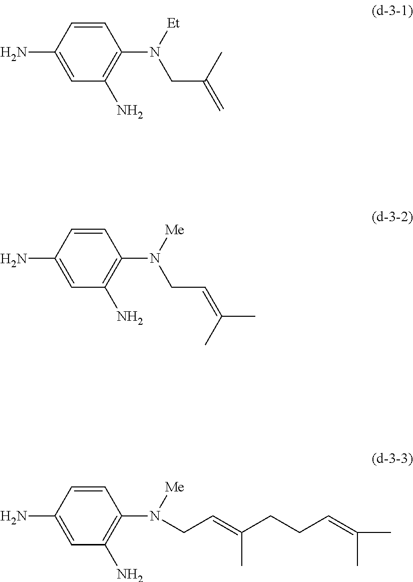 [SMILES: C=C(C)CN(CC)c1ccc(N)cc1N ; CC(C)=CCN(C)c1ccc(N)cc1N ; CC(C)=CCC/C(C)=C/CN(C)c1ccc(N)cc1N]

Compound represented by formula (d-4)

The divalent group represented by —X⁴—(R⁷—X⁵)ₖ— in the formula (d-4) is preferably an alkanediyl group having 1 to 3 carbon atoms, *—O—, *—OCO—, or *—O—C₂H₄—O— (that is bonded to the diaminophenyl group at the bonding position indicated by “*”).

The group represented by —C_{c}H_{2c+1} is preferably linear. Specific examples of the group represented by —C_{c}H_{2c+1} include a methyl group, an ethyl group, an n-propyl group, an n-butyl group, an n-pentyl group, an n-hexyl group, an n-heptyl group, an n-octyl group, an n-nonyl group, an n-decyl group, an n-dodecyl group, an n-tridecyl group, an n-tetradecyl group, an n-pentadecyl group, an n-hexadecyl group, an n-heptadecyl group, an n-octadecyl group, an n-nonadecyl group, an n-eicosyl group, and the like.

The bonding positions of the two primary amino groups included in the diaminophenyl group are preferably the 2,4-positions or the 3,5-positions (more preferably the 2,4-positions) relative to the group represented by X⁴. A hydrogen atom on the benzene ring to which the primary amino group is bonded may be substituted with a monovalent hydrocarbon group having 1 to 10 carbon atoms, a monovalent group obtained by substituting at least one hydrogen atom of the hydrocarbon group with a fluorine atom, or a fluorine atom.

Specific examples of a preferable compound represented by the formula (d-4) include the compounds respectively represented by the following formulas (d-4-1) to (d-4-11), and the like.

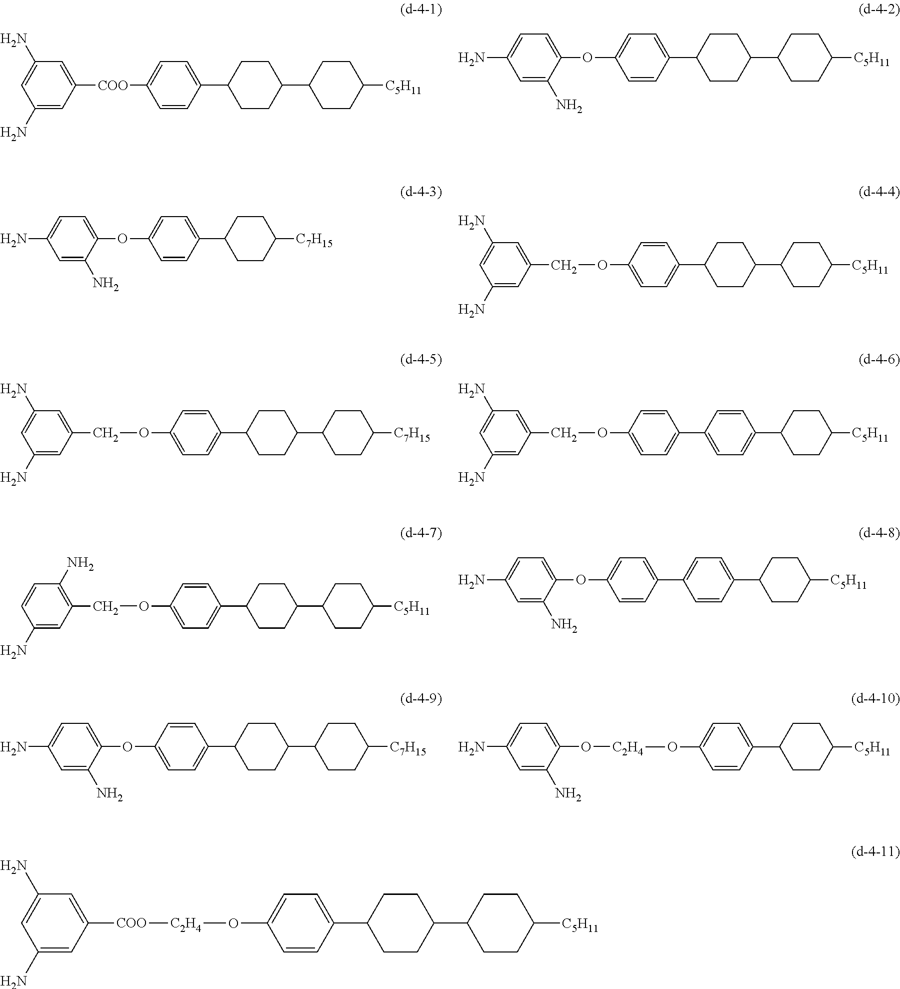

The specific diamine used to synthesize the polyamic acid may be appropriately selected from the above compounds corresponding to the drive mode of the liquid crystal display. Specifically, a liquid crystal aligning agent suitable for producing an FFS-mode liquid crystal display can be prepared by utilizing the compound represented by the formula (d−1) as the specific diamine. A liquid crystal aligning agent suitable for producing a TN or FFS-mode liquid crystal display can be prepared by utilizing at least one compound selected from the group consisting of the compound represented by the formula (d-2) and the compound represented by the formula (d-3) as the specific diamine. A liquid crystal aligning agent suitable for producing a VA-mode liquid crystal display can be prepared by utilizing the compound represented by the formula (d-4) as the specific diamine.

### Additional Diamine

A compound (additional diamine) other than the specific diamine may be used as the diamine used to synthesize the polyamic acid. The additional diamine may be an aliphatic diamine, an alicyclic diamine, an aromatic diamine, or a diaminoorganosiloxane. Specific examples of the aliphatic diamine include m-xylylenediamine, 1,3-propanediamine, tetramethylenediamine, pentamethylenediamine, hexamethylenediamine, and the like. Specific examples of the alicyclic diamine include 1,4-diaminocyclohexane, 4,4′-methylenebis(cyclohexylamine), 1,3-bis(aminomethyl)cyclohexane, and the like.

Specific examples of the aromatic diamine include p-phenylenediamine, 4,4′-diaminodiphenyl sulfide, 1,5-diaminonaphthalene, 2,2′-dimethyl-4,4′-diaminobiphenyl, 2,2′-bis(trifluoromethyl)-4,4′-diaminobiphenyl, 2,7-diaminofluorene, 4,4′-diaminodiphenyl ether, 2,2-bis[4-(4-aminophenoxy)phenyl]propane, 9,9-bis(4-aminophenyl)fluorene, 2,2-bis[4-(4-aminophenoxy)phenyl]hexafluoropropane, 2,2-bis(4-aminophenyl)hexafluoropropane, 4,4′-(p-phenylenediisopropylidene)bisaniline, 4,4′-(m-phenylenediisopropylidene)bisaniline, 1,4-bis(4-aminophenoxy)benzene, 4,4′-bis(4-aminophenoxy)biphenyl, 2,6-diaminopyridine, 3,4-diaminopyridine, 2,4-diaminopyrimidine, 3,6-diaminoacridine, 3,6-diaminocarbazole, n-methyl-3,6-diaminocarbazole, n-ethyl-3,6-diaminocarbazole, n-phenyl-3,6-diaminocarbazole, N,N′-bis(4-aminophenyl)benzidine, N,N′-bis(4-aminophenyl)-N,N′-dimethylbenzidine, 1,4-bis(4-aminophenyl)piperazine, 1-(4-aminophenyl)-2,3-dihydro-1,3,3-trimethyl-1H-indene-5-amine, 1-(4-aminophenyl)-2,3-dihydro-1,3,3-trimethyl-1H-indene-6-amine, 3,5-diaminobenzoic acid, cholestanyloxy-3,5-diaminobenzene, cholestenyloxy-3,5-diaminobenzene, cholestanyloxy-2,4-diaminobenzene, cholestenyloxy-2,4-diaminobenzene, cholestanyl 3,5-diaminobenzoate, cholestenyl 3,5-diaminobenzoate, lanostanyl 3,5-diaminobenzoate, 3,6-bis(4-aminobenzoyloxy)cholestane, 3,6-bis(4-aminophenoxy)cholestane, 4-(4′-trifluoromethoxybenzoyloxy)cyclohexyl 3,5-diaminobenzoate, 4-(4′-trifluoromethylbenzoyloxy)cyclohexyl-3,5-diaminobenzoate, 1,1-bis(4-((aminophenyl)methyl)phenyl)-4-butylcyclohexane, 1,1-bis(4-((aminophenyl)methyl)phenyl)-4-heptylcyclohexane, 1,1-bis(4-((aminophenoxy)methyl)phenyl)-4-heptylcyclohexane, 1,1-bis(4-((aminophenyl)methyl)phenyl)-4-(4-heptylcyclohexyl)cyclohexane, 4-aminobenzylamine, 3-aminobenzylamine, 2,2-bis[4-(4-aminophenoxy)phenyl]propane, and the like. Specific examples of the diaminoorganosiloxane include 1,3-bis(3-aminopropyl)tetramethyldisiloxane and the like. The diamines disclosed in Japanese Patent Application Publication (KOKAI) No. 2010-97188 may also be used. These additional diamines may be used either alone or in combination.

When synthesizing the polyamic acid, the specific diamine may be used in an arbitrary amount depending on the compound used as the specific diamine. For example, the compound represented by the formula (d−1) is preferably used in a ratio of 10 mol % or more, and more preferably 30 mol % or more, based on the total amount of diamines. The compound represented by the formula (d-2) is preferably used in a ratio of 10 to 100 mol %, more preferably 30 to 100 mol %, and still more preferably 50 to 100 mol %, based on the total amount of diamines, from the viewpoint of ensuring that the liquid crystal molecules have a low pretilt angle.

The compound represented by the formula (d-3) is preferably used in a ratio of 5 mol % or more, and more preferably 10 mol % or more, based on the total amount of diamines, from the viewpoint of improving the stability of the voltage holding ratio. The compound represented by the formula (d-3) is preferably used in a ratio of 90 mol % or less, more preferably 80 mol % or less, and still more preferably 70 mol % or less. The compound represented by the formula (d-4) is preferably used in a ratio of 5 to 100 mol %, and more preferably 10 to 100 mol %, based on the total amount of diamines, from the viewpoint of ensuring excellent vertical alignment. The compounds mentioned above may be used either alone or in combination as the specific diamine.

When producing the liquid crystal aligning agent for a TN or FFS-mode liquid crystal display, a monoamine represented by the following formula (m−1) may be used when synthesizing the polyamic acid in order to ensure that the liquid crystal molecules have a moderate pretilt angle.

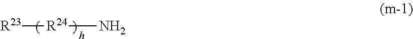

wherein R²³ is an alkyl group having 6 to 20 carbon atoms, R²⁴ is a divalent organic group, and h is 0 or 1.

The alkyl group having 6 to 20 carbon atoms represented by R²³ in the formula (m−1) may be linear or branched. Examples of the alkyl group having 6 to 20 carbon atoms represented by R²³ include an n-hexyl group, an n-heptyl group, an n-octyl group, an n-nonyl group, an n-decyl group, an n-dodecyl group, an n-tridecyl group, an n-tetradecyl group, an n-pentadecyl group, an n-hexadecyl group, an n-heptadecyl group, an n-octadecyl group, an n-nonadecyl group, an n-eicosyl group, a 1,3-dimethylbutyl group, a 1,5-dimethylhexyl group, and the like. The divalent organic group represented by R²⁴ is an aliphatic group, an aromatic group, or a derivative thereof.

Specific examples of a preferable monoamine represented by the formula (m−1) include aliphatic monoamines such as n-hexylamine, n-octylamine, n-decylamine, n-dodecylamine, n-hexadecylamine, 1,3-dimethylbutylamine, 1,5-dimethylhexylamine, and 2-ethylhexylamine; aromatic monoamines such as p-aminophenylhexane, p-aminophenyloctane, p-aminophenyldodecane, p-aminophenylhexadecane, p-aminophenoxyoctane, p-aminophenoxydodecane, and p-aminophenoxyhexadecane; and the like.

The monoamine is preferably used so that “2(a-b)≧c>0” (where, a is the number of moles of the tetracarboxylic dianhydride, b is the number of moles of the diamine, and c is the number of moles of the monoamine) is satisfied, from the viewpoint of suppressing a situation in which free monoamines present in the resulting liquid crystal cell adversely affect the display characteristics.

The monoamine represented by the formula (m−1) may be reacted and polymerized with a reaction product of the tetracarboxylic dianhydride and the diamine, or the tetracarboxylic dianhydride, the diamine, and the monoamine may be reacted and polymerized at the same time.

### Molecular Weight Modifier

When synthesizing the polyamic acid, an appropriate molecular weight modifier may be used together with the tetracarboxylic dianhydride and the diamine to synthesize a terminal-modified polymer. The applicability (printability) of the liquid crystal aligning agent can be further improved without impairing the advantageous effects of the invention by synthesizing such a terminal-modified polymer.

Examples of the molecular weight modifier include an acid monoanhydride, a monoamine compound, a monoisocyanate compound, and the like. Specific examples of the acid monoanhydride include maleic anhydride, phthalic anhydride, itaconic anhydride, n-decylsuccinic anhydride, n-dodecylsuccinic anhydride, n-tetradecylsuccinic anhydride, n-hexadecylsuccinic anhydride, and the like. Specific examples of the monoamine compound include aniline, cyclohexylamine, n-butylamine, the compound represented by the formula (m−1), and the like. Specific examples of the monoisocyanate compound include phenyl isocyanate, naphthyl isocyanate, and the like.

The molecular weight modifier is preferably used in an amount of 20 parts by weight or less, and more preferably 10 parts by weight or less, based on 100 parts by weight of the tetracarboxylic dianhydride and the diamine in total.

Synthesis of polyamic acid

The tetracarboxylic dianhydride and the diamine used to synthesize the polyamic acid are preferably used so that the amount of the acid anhydride groups of the tetracarboxylic dianhydride is 0.2 to 2 equivalents, and more preferably 0.3 to 1.2 equivalents, based on 1 equivalent of the amino groups of the diamine.

The polyamic acid is preferably synthesized in an organic solvent. The reaction temperature is preferably −20 to 150° C., and more preferably 0 to 100° C. The reaction time is preferably 0.1 to 24 hours, and more preferably 0.5 to 12 hours.

Examples of the organic solvent include an aprotic polar solvent, a phenol-based solvent, an alcohol, a ketone, an ester, an ether, a halogenated hydrocarbon, a hydrocarbon, and the like.

Specific examples of the aprotic polar solvent include N-methyl-2-pyrrolidone, 1,3-dimethyl-2-imidazolidinone, N-ethyl-2-pyrrolidone, N,N-dimethylacetamide, N,N-dimethylformamide, dimethyl sulfoxide, γ-butyrolactone, tetramethylurea, hexamethylphosphortriamide, and the like. Specific examples of the phenol-based solvent include phenol, m-cresol, xylenol, a halogenated phenol, and the like.

Specific examples of the alcohol include methyl alcohol, ethyl alcohol, isopropyl alcohol, cyclohexanol, ethylene glycol, propylene glycol, 1,4-butanediol, triethylene glycol, ethylene glycol monomethyl ether, and the like. Specific examples of the ketone include acetone, methyl ethyl ketone, methyl isobutyl ketone, cyclohexanone, and the like. Specific examples of the ester include ethyl lactate, butyl lactate, methyl acetate, ethyl acetate, butyl acetate, methyl methoxypropionate, ethyl ethoxypropionate, diethyl oxalate, diethyl malonate, isoamyl propionate, isoamyl isobutyrate, and the like. Specific examples of the ether include diethyl ether, ethylene glycol methyl ether, ethylene glycol ethyl ether, ethylene glycol n-propyl ether, ethylene glycol i-propyl ether, ethylene glycol n-butyl ether, ethylene glycol dimethyl ether, ethylene glycol ethyl ether acetate, diethylene glycol dimethyl ether, diethylene glycol diethyl ether, diethylene glycol monomethyl ether, diethylene glycol monoethyl ether, diethylene glycol monomethyl ether acetate, diethylene glycol monoethyl ether acetate, tetrahydrofuran, diisopentyl ether, and the like. Specific examples of the halogenated hydrocarbon include dichloromethane, 1,2-dichloroethane, 1,4-dichlorobutane, trichloroethane, chlorobenzene, o-dichlorobenzene, and the like. Specific examples of the hydrocarbon include hexane, heptane, octane, benzene, toluene, xylene, and the like.

It is preferable to use one or more compounds selected from the group (first group) consisting of the aprotic polar solvent and the phenol-based solvent, or a mixture of one or more compounds selected from the first group and one or more compounds selected from the group (second group) consisting of the alcohol, the ketone, the ester, the ether, the halogenated hydrocarbon, and the hydrocarbon. In the latter case, one or more compounds selected from the second group are preferably used in a ratio of 50 wt % or less, more preferably 40 wt % or less, and still more preferably 30 wt % or less, based on the total amount of one or more compounds selected from the first group and one or more compounds selected from the second group.

The amount (a) of the organic solvent is preferably adjusted so that the total amount (b) of the tetracarboxylic dianhydride and the diamine is 0.1 to 50 wt % based on the total amount (a+b) of the reaction solution.

A reaction solution in which the polyamic acid is dissolved is thus obtained. The reaction solution may be used directly to prepare the liquid crystal aligning agent, or the polyamic acid isolated from the reaction solution may be used to prepare the liquid crystal aligning agent, or the polyamic acid isolated from the reaction solution and then purified may be used to prepare the liquid crystal aligning agent. When subjecting the polyamic acid to a dehydration/ring-closing reaction to produce a polyimide, the reaction solution may be subjected directly to a dehydration/ring-closing reaction, or the polyamic acid isolated from the reaction solution may be subjected to a dehydration/ring-closing reaction, or the polyamic acid isolated from the reaction solution and then purified may be subjected to a dehydration/ring-closing reaction. The polyamic acid may be isolated and purified using a known method.

### Polyimide and Synthesis of Polyimide

The polyimide used as the polymer (A) may be obtained by subjecting the polyamic acid synthesized as described above to a dehydration/ring-closing reaction to effect imidization.

The polyimide may be a completely imidized product obtained by subjecting all of the amic acid structures of the polyamic acid (precursor) to a dehydration/ring-closing reaction, or may be a partially imidized product obtained by subjecting only some of the amic acid structures of the polyamic acid to a dehydration/ring-closing reaction, and including an amic acid structure and an imide ring structure. The degree of imidization of the polyimide used as the polymer (A) is preferably 30% or more, more preferably 40 to 99%, and still more preferably 50 to 99%. The degree of imidization (%) refers to the ratio of the number of imide ring structures included in the polyimide to the sum of the number of amic acid structures and the number of imide ring structures. Some of the imide rings may be an isoimide ring.

The polyamic acid is preferably subjected to a dehydration/ring-closing reaction by heating the polyamic acid, or dissolving the polyamic acid in an organic solvent, and adding a dehydrating agent and a dehydration/ring-closing catalyst to the solution, followed by optional heating. It is preferable to use the latter method.

Examples of the dehydrating agent added to the solution of the polyamic acid include acid anhydrides such as acetic anhydride, propionic anhydride, and trifluoroacetic anhydride. The dehydrating agent is preferably used in an amount of 0.01 to 20 mol based on 1 mol of the amic acid structures of the polyamic acid. Examples of the dehydration/ring-closing catalyst include tertiary amines such as pyridine, collidine, lutidine, and triethylamine. The dehydration/ring-closing catalyst is preferably used in an amount of 0.01 to 10 mol based on 1 mol of the dehydrating agent. Examples of the organic solvent used for the dehydration/ring-closing reaction include those mentioned above in connection with the organic solvent used when synthesizing the polyamic acid. The dehydration/ring-closing reaction temperature is preferably 0 to 180° C., and more preferably 10 to 150° C. The dehydration/ring-closing reaction time is preferably 1.0 to 120 hours, and more preferably 2.0 to 30 hours.

A reaction solution that includes the polyimide is thus obtained. The reaction solution may be used directly to prepare the liquid crystal aligning agent, or the reaction solution may be used to prepare the liquid crystal aligning agent after removing the dehydrating agent and the dehydration/ring-closing catalyst from the reaction solution, or the polyimide isolated from the reaction solution may be used to prepare the liquid crystal aligning agent, or the polyimide isolated from the reaction solution and then purified may be used to prepare the liquid crystal aligning agent. The purification operation may be performed using a known method.

### Polyamic Ester and Synthesis of Polyamic Ester

The polyamic ester used as the polymer (A) may be synthesized by [I] reacting the tetracarboxylic dianhydride and the diamine mentioned above in connection with the compounds used to synthesize the polyamic acid to obtain a polyamic acid, and reacting the resulting polyamic acid with an epoxy group-containing compound, a hydroxyl group-containing compound, or a halide (hereinafter referred to as “method [I]”), or [II] reacting a tetracarboxylic diester and a diamine (hereinafter referred to as “method [II]”), or [III] reacting a tetracarboxylic diester dihalide and a diamine (hereinafter referred to as “method [III]”), for example.

Examples of the epoxy group-containing compound used for the method [I] include propylene oxide and the like. Examples of the hydroxyl group-containing compound used for the method [I] include alcohols such as methanol, ethanol, and propanol; phenols such as phenol and cresol; and the like. Examples of the halide used for the method [I] include methyl bromide, ethyl bromide, stearyl bromide, methyl chloride, stearyl chloride, 1,1,1-trifluoro-2-iodoethane, and the like.

The tetracarboxylic diester used for the method [II] may be obtained by subjecting the tetracarboxylic dianhydride mentioned above in connection with synthesis of the polyamic acid to a ring-opening reaction using the above alcohol, for example. The reaction employed in the method [II] is preferably effected in the presence of an appropriate dehydration catalyst. Examples of the dehydration catalyst include 4-(4,6-dimethoxy-1,3,5-triazin-2-yl)-4-methylmorpholinium halide, carbonylimidazole, a phosphorus-based condensation agent, and the like. The tetracarboxylic diester dihalide used for the method [III] may be obtained by reacting the tetracarboxylic diester obtained as described above with an appropriate chlorinating agent such as thionyl chloride, for example. Examples of the diamine used for the method [II] and the method [III] include those mentioned above in connection with the diamine used to synthesize the polyamic acid. Note that the polyamic ester may include only an amic ester structure, or may be a partially esterified product that includes an amic acid structure and an amic ester structure.

### Solution Viscosity and Weight Average Molecular Weight

It is preferable that a 10 wt % solution of the polyamic acid, the polyimide, or the polyamic ester obtained as described above have a viscosity of 10 to 800 mPa·s, and more preferably 15 to 500 mPa·s. Note that the viscosity (mPa·s) of the solution of the polymer refers to the viscosity (measured at 25° C. using an E-type rotational viscometer) of a 10 wt % polymer solution prepared using a good solvent (e.g., γ-butyrolactone or N-methyl-2-pyrrolidone) for the polymer.

The reduced viscosity is not particularly limited as long as a uniform film can be formed. The reduced viscosity is preferably 0.05 to 3.0 dl/g, more preferably 0.1 to 2.5 dl/g, and still more preferably 0.3 to 1.5 dl/g.

The polystyrene-reduced weight average molecular weight of the polyamic acid, the polyimide, and the polyamic ester used for the liquid crystal aligning agent, determined by gel permeation chromatography (GPC), is preferably 500 to 100,000, and more preferably 1000 to 50,000.

### Solvent

Examples of the solvent that may be used for preparing the liquid crystal aligning agent include N-methyl-2-pyrrolidone, γ-butyrolactone, γ-butyrolactam, N,N-dimethylformamide, N,N-dimethylacetamide, 4-hydroxy-4-methyl-2-pentanone, ethylene glycol monomethyl ether, butyl lactate, butyl acetate, methyl methoxypropionate, ethyl ethoxypropionate, ethylene glycol methyl ether, ethylene glycol ethyl ether, ethylene glycol n-propyl ether, ethylene glycol i-propyl ether, ethylene glycol n-butyl ether (butyl cellosolve), ethylene glycol dimethyl ether, ethylene glycol ethyl ether acetate, diethylene glycol dimethyl ether, diethylene glycol diethyl ether, diethylene glycol monomethyl ether, diethylene glycol monoethyl ether, diethylene glycol monomethyl ether acetate, diethylene glycol monoethyl ether acetate, dipropylene glycol monomethyl ether (DPM), diisobutyl ketone, isoamyl propionate, isoamyl isobutyrate, diisopentyl ether, ethylene carbonate, propylene carbonate, and the like. These solvents may be used either alone or in combination.

### Additive

The liquid crystal aligning agent may optionally include an additional component other than the polymer (A) and the solvent. Examples of the additional component include an additional polymer other than the polymer (A), a compound that includes at least one epoxy group in the molecule (hereinafter referred to as “epoxy group-containing compound”), a functional silane compound, and the like.

### Additional Polymer

The additional polymer may be used to achieve an improvement in solution properties and electrical properties. Examples of the additional polymer include polyorganosiloxanes, polyester, polyamides, cellulose derivatives, polyacetals, polystyrene derivatives, poly(styrene-phenylmaleimide) derivatives, poly(meth)acrylates, and the like. The additional polymer is preferably used in a ratio of 50 wt % or less, more preferably 0.1 to 40 wt %, and still more preferably 0.1 to 30 wt %, based on the total amount of polymers included in the liquid crystal aligning agent.

### Epoxy Group-Containing Compound

The epoxy group-containing compound is used to improve the adhesion of the liquid crystal alignment film to the surface of the substrate. Examples of the epoxy group-containing compound include ethylene glycol diglycidyl ether, polyethylene glycol diglycidyl ether, propylene glycol diglycidyl ether, tripropylene glycol diglycidyl ether, polypropylene glycol diglycidyl ether, neopentyl glycol diglycidyl ether, 1,6-hexanediol diglycidyl ether, glycerol diglycidyl ether, trimethylolpropane triglycidyl ether, 2,2-dibromoneopentyl glycol diglycidyl ether, N,N,N′,N′-tetraglycidyl-m-xylenediamine, 1,3-bis(N,N-diglycidylaminomethyl)cyclohexane, N,N,N′,N′-tetraglycidyl-4,4′-diaminodiphenylmethane, N,N-diglycidylbenzylamine, N,N-diglycidylaminomethylcyclohexane, N,N-diglycidylcyclohexylamine, and the like.

The epoxy group-containing compound is preferably used in an amount of 40 parts by weight or less, and more preferably 0.1 to 30 parts by weight, based on 100 parts by weight (total amount) of polymers included in the liquid crystal aligning agent.

### Functional Silane Compound

The functional silane compound is used to improve the printability of the liquid crystal aligning agent. Examples of the functional silane compound include 3-aminopropyltrimethoxysilane, 3-aminopropyltriethoxysilane, 2-aminopropyltrimethoxysilane, 2-aminopropyltriethoxysilane, N-(2-aminoethyl)-3-aminopropyltrimethoxysilane, N-(2-aminoethyl)-3-aminopropylmethyldimethoxysilane, 3-ureidopropyltrimethoxysilane, 3-ureidopropyltriethoxysilane, N-ethoxycarbonyl-3-aminopropyltrimethoxysilane, N-triethoxysilylpropyltriethylenetriamine, 10-trimethoxysilyl-1,4,7-triazadecane, 9-trimethoxysilyl-3,6-diazanonyl acetate, 9-trimethoxysilyl-3,6-diazamethyl nonanoate, N-benzyl-3-aminopropyltrimethoxysilane, N-phenyl-3-aminopropyltrimethoxysilane, glycidoxymethyltrimetoxysilane, 2-glycidoxyethyltrimethoxysilane, 3-glycidoxypropyltrimetoxysilane, and the like.

The functional silane compound is preferably used in an amount of 2 parts by weight or less, and more preferably 0.02 to 0.2 parts by weight, based on 100 parts by weight (total amount) of polymers included in the liquid crystal aligning agent.

A compound that includes at least one oxetanyl group in the molecule, an antioxidant, or the like may also be added to the liquid crystal aligning agent.

The solid content (i.e., the ratio of the total weight of the components other than the solvent to the total weight of the liquid crystal aligning agent) in the liquid crystal aligning agent is appropriately selected taking account of the viscosity, the volatility, and the like of the liquid crystal aligning agent, but is preferably 1 to 10 wt %. The liquid crystal aligning agent is applied to the surface of a substrate, and preferably heated to form a liquid crystal alignment film (or a film that is further treated to form a liquid crystal alignment film) (described later). If the solid content is less than 1 wt %, the resulting film may have too small a thickness, and a good liquid crystal alignment film may not be obtained. If the solid content exceeds 10 wt %, the resulting film may have too large a thickness, and a good liquid crystal alignment film may not be obtained. Moreover, the liquid crystal aligning agent may exhibit poor applicability due to an increase in viscosity.

A particularly preferable solid content differs depending on a method used when applying the liquid crystal aligning agent to the substrate. For example, when applying the liquid crystal aligning agent to the substrate using a spin coating method, it is particularly preferable to adjust the solid content to 1.5 to 4.5 wt %. When applying the liquid crystal aligning agent to the substrate using an offset printing method, it is particularly preferable to adjust the solid content to 3 to 9 wt % so that the viscosity of the solution is 12 to 50 mPa·s. When applying the liquid crystal aligning agent to the substrate using an inkjet method, it is particularly preferable to adjust the solid content to 1 to 5 wt % so that the viscosity of the solution is 3 to 15 mPa·s. The liquid crystal aligning agent is preferably prepared at 10 to 50° C., and more preferably 20 to 30° C.

### Production of Liquid Crystal Display

The liquid crystal display according to one embodiment of the invention may be produced using the liquid crystal composition and the liquid crystal aligning agent that are prepared as described above. The drive mode of the liquid crystal display according to one embodiment of the invention is not particularly limited. The liquid crystal display according to one embodiment of the invention may be applied to various drive modes such as a TN mode, an STN mode, an IPS mode, an FFS mode, a VA mode, and an MVA mode. The liquid crystal display according to one embodiment of the invention may be produced by a method that includes the following steps (1) and (2), for example. The substrate used in the step (1) differs depending on the desired drive mode. The step (2) is common to each drive mode.

### Step (1): Formation of Film

In the step (1), the liquid crystal aligning agent is applied to the surface of each of a pair of substrates, and heated to form a film on the surface of each of the pair of substrates. (1-1) When producing a TN, STN, VA, or MVA-mode liquid crystal display, a pair of substrates on which a patterned transparent conductive film is formed is provided, and the liquid crystal aligning agent is applied to the surface of each substrate on which the transparent conductive film is formed (preferably using an offset printing method, a spin coating method, a roll coating method, or an inkjet printing method). The substrate may be a transparent substrate formed of glass (e.g., float glass or soda glass) or a plastic (e.g., polyethylene terephthalate, polybutylene terephthalate, polyethersulfone, polycarbonate, or poly(alicyclic olefin)). The transparent conductive film formed on the surface of the substrate may be a NESA film (“NESA” is a registered trademark of PPG Industries (USA)) formed of tin oxide (SnO₂), an ITO film formed of indium oxide-tin oxide (In₂O₃—SnO₂), or the like. The patterned transparent conductive film may be obtained by forming an unpatterned transparent conductive film, and patterning the unpatterned transparent conductive film by photoetching, or utilizing a mask having a desired pattern when forming a transparent conductive film, for example. A functional silane compound, a functional titanium compound, or the like may be applied to the surface of the substrate on which a film is to be formed before applying the liquid crystal aligning agent in order to improve adhesion between the surface of the substrate (transparent conductive film) and the resulting film.

After applying the liquid crystal aligning agent, the liquid crystal aligning agent is preferably prebaked in order to prevent the applied liquid crystal aligning agent from dripping, for example. The prebaking temperature is preferably 30 to 200° C., more preferably 40 to 150° C., and particularly preferably 40 to 100° C. The prebaking time is preferably 0.25 to 10 minutes, and more preferably 0.5 to 5 minutes. The liquid crystal aligning agent is then post-baked in order to completely remove the solvent, and optionally effect thermal imidization of the amic acid structure present in the polymer. The post-baking temperature is preferably 80 to 300° C., and more preferably 120 to 250° C. The post-baking time is preferably 5 to 200 minutes, and more preferably 10 to 100 minutes. The thickness of the resulting film is preferably 0.001 to 1 μm, and more preferably 0.005 to 0.5 μm.

(1-2) When producing an IPS or FFS-mode liquid crystal display, the liquid crystal aligning agent is applied to the surface of a substrate on which a comb-like electrode (transparent conductive film or metal film) is formed, and the surface of a common substrate on which an electrode is not formed, and heated to form a film. A material of the substrate, a material of the transparent conductive film, the application (coating) method, heating conditions after application, the transparent conductive film/metal film patterning method, the substrate pretreatment, and a preferable thickness of the film are the same as described above (see (1-1)). A film formed of a metal such as chromium may be used as the metal film.

After applying the liquid crystal aligning agent to the substrate as described in the section (1-1) or (1-2), the organic solvent is removed to obtain a film (liquid crystal alignment film). When the polymer included in the liquid crystal aligning agent is a polyamic acid, a polyamic ester, or an imidized polymer that includes an imide ring structure and an amic acid structure, the film may be further heated to effect a dehydration/ring-closing reaction to obtain an imidized film.

### Step (1′): Rubbing Treatment

When producing a TN, STN, IPS, or FFS-mode liquid crystal display, the film formed by the step (1) is rubbed in a given direction using a roll around which a fiber cloth (e.g., nylon, rayon, or cotton) is wound (rubbing treatment). The film is thus provided with a liquid crystal molecule alignment capability to obtain a liquid crystal alignment film. When producing a VA-mode liquid crystal display, the film formed by the step (1) may be used directly as the liquid crystal alignment film (without rubbing). Note that the film may be subjected to the rubbing treatment.

The liquid crystal alignment film subjected to the rubbing treatment may be subjected to a treatment that changes the pretilt angle of part of the liquid crystal alignment film by applying UV rays to part of the liquid crystal alignment film, or a treatment that forms a resist film on part of the surface of the liquid crystal alignment film, and subjects the liquid crystal alignment film to the rubbing treatment in a direction differing from that of the previous rubbing treatment, and removes the resist film so that the liquid crystal alignment film has a different liquid crystal alignment capability depending on the area. In this case, the viewing characteristics of the resulting liquid crystal display can be improved.

### Step (2): Production of Liquid Crystal Cell

In the step (2), two substrates on which the liquid crystal alignment film is formed as described above are provided, and the liquid crystal layer is disposed between the substrates that are disposed to face each other to produce a liquid crystal cell. The liquid crystal cell may be produced using the following first or second method, for example.

The first method is a known method. Specifically, the two substrates are disposed through a cell gap so that the liquid crystal alignment films face each other, and are bonded in the peripheral area using a sealant. After filling the cell gap defined by the surface of the substrate and the sealant with the liquid crystal composition, the injection hole is sealed to produce a liquid crystal cell. The second method utilizes an one-drop-fill (ODF) technique. Specifically, a UV-curable sealant is applied to a given area of one of the two substrates on which the liquid crystal alignment film is formed, for example. After dropping the liquid crystal composition onto several areas of the liquid crystal alignment film, the substrates are bonded so that the liquid crystal alignment films face each other, and a liquid crystal is spread over the entire surface of the substrate. The sealant is then cured by applying ultraviolet light to the entire surface of the substrate to produce a liquid crystal cell. When using the first method or the second method, it is desirable to heat the liquid crystal cell up to a temperature at which the liquid crystal is in an isotropic phase, and gradually cool the liquid crystal cell to room temperature to remove the flow alignment of the liquid crystal that has occurred during filling. A liquid crystal layer that includes the cyclohexane compound represented by the formula (1) is thus formed between the pair of substrates on which the liquid crystal alignment film is formed.

An epoxy resin that includes a curing agent and aluminum oxide balls (i.e., spacer) may be used as the sealant.

A polarizer is then bonded to the outer surface of the liquid crystal cell to produce the liquid crystal display according to one embodiment of the invention. Examples of the polarizer that is bonded to the outer surface of the liquid crystal cell include a polarizer in which a polarizing film (H film) obtained by stretching polyvinyl alcohol while effecting absorption of iodine is interposed between cellulose acetate protective films, and a polarizer formed of an H film. When the film is subjected to the rubbing treatment, the substrates are disposed to face each other so that the rubbing directions of the films form a given angle (e.g., orthogonal or antiparallel).

The liquid crystal display according to one embodiment of the invention may suitably be applied to various devices. For example, the liquid crystal display according to one embodiment of the invention may be used as a display for a clock, a portable game device, a word processor, a notebook-sized personal computer, a car navigation system, a camcoder, a PDA, a digital camera, a mobile phone, a smartphone, a monitor, an LCD TV, and the like.

### EXAMPLES

The invention is further described below by way of examples. Note that the invention is not limited to the following examples.

The viscosity of the polymer solution and the degree of imidization of the polyimide were measured by the following methods.

### Viscosity of Polymer Solution

The viscosity (mPa·s) of the polymer solution was measured at 25° C. using an E-type rotational viscometer.

### Degree of Imidization of Polyimide

A solution of the polyimide was added to purified water. The resulting precipitates were sufficiently dried at room temperature under reduced pressure, and dissolved in deuterated dimethyl sulfoxide. The solution was subjected to ¹H-NMR analysis at room temperature (standard: tetramethylsilane). The degree of imidization (%) was calculated from the resulting ¹H-NMR spectrum using the following expression (x).

Degree of imidization (%)=(1−A¹/A²×a)×100 (x)

where, A¹ is a peak area attributed to the proton of an NH group that appears at about 10 ppm of the chemical shift, A² is a peak area attributed to other protons, and a is the ratio of the number of other protons to one proton of an NH group in the polymer precursor (polyamic acid).

### Synthesis of Polyamic Acid

### Synthesis Example 1

15.63 g of 1,2,3,4-cyclobutanetetracarboxylic dianhydride (tetracarboxylic dianhydride), 5.04 g of pyromellitic dianhydride (tetracarboxylic dianhydride), 3.89 g of 3,4-dicarboxy-1,2,3,4-tetrahydro-1-naphthalenesuccinic anhydride (tetracarboxylic dianhydride), 15.97 g of 4,4′-diaminodiphenylamine (diamine), 6.41 g of 1,5-bis(4-aminophenoxy)pentane (diamine), and 3.03 g of 4,4′-diaminodiphenylmethane (diamine) were dissolved in 200 g of N-methyl-2-pyrrolidone (NMP), and reacted at 60° C. for 4 hours. The reaction mixture was poured into a large excess of methanol to precipitate the reaction product. The reaction product was collected, washed with methanol, and dried at 40° C. for 15 hours under reduced pressure to obtain a polyamic acid (PA-1). The polyamic acid (PA-1) was dissolved in NMP at a concentration of 10 wt %, and the viscosity of the solution was measured, and found to be 980 mPa·s.

### Synthesis Example 2

A 50 ml four-necked flask equipped with a stirrer and a nitrogen introduction tube was charged with 0.60 g (2.0 mmol) of 1,3-bis(4-aminophenethyl)urea (BAPU) (diamine) and 1.95 g (18.0 mmol) of p-phenylenediamine (p-PDA) (diamine). After the addition to 30 g of N-methyl-2-pyrrolidone (NMP), the mixture was stirred while supplying nitrogen to prepare a diamine solution. After the addition of 3.70 g (18.9 mmol) of 1,2,3,4-cyclobutanetetracarboxylic dianhydride (CBDA) (tetracarboxylic dianhydride) to the diamine solution with stirring, NMP was added to the mixture so that the solid content was 10 wt %. The mixture was stirred at room temperature for 4 hours under a nitrogen atmosphere to obtain a solution of a polyamic acid (PA-2).

### Synthesis Example 3

14.64 g (0.072 mol) of 2,4-diamino-N,N-diallylaniline (diamine), 2.96 g (0.016 mol) of n-dodecylamine (monoamine), and 15.69 g (0.08 mol) of CBDA (tetracarboxylic dianhydride) were reacted at room temperature for 4 hours in 250 g of NMP. NMP was added to the mixture so that the solid content was 10 wt % to obtain a solution of a polyamic acid (PA-3).

### Synthesis Example 4

6.5 g (0.06 mol) of p-PDA (diamine) and 15.22 g (0.04 mol) of 4-(4-trans-n-heptylcyclohexyl)phenoxy)-2,4-diaminobenzene (diamine) were dissolved in 165 g of NMP. After the addition of 19.41 g (0.099 mol) of CBDA (tetracarboxylic dianhydride), the mixture was reacted at room temperature for 24 hours. NMP was added to the mixture so that the solid content was 10 wt % to obtain a solution of a polyamic acid (PA-4).

### Synthesis of Polyimide

### Synthesis Example 5

19.61 g of bicyclo[3.3.0]octane-2,4,6,8-tetracarboxylic 2:4,6:8-dianhydride (tetracarboxylic dianhydride), 5.12 g of 1,2,3,4-cyclobutanetetracarboxylic dianhydride (tetracarboxylic dianhydride), 13.90 g of the compound represented by the following formula (DA-1) (diamine), and 11.35 g of 3,5-diaminobenzoic acid (diamine) were dissolved in 200 g of NMP, and reacted at 60° C. for 4 hours to obtain a polyamic acid solution. A small amount of the polyamic acid solution was collected preparatively, and the viscosity of the collected solution was measured, and found to be 700 mPa·s. After the addition of 250 g of NMP, 16.53 g of pyridine, and 21.34 g acetic anhydride to the polyamic acid solution, a dehydration/ring-closing reaction was effected at 110° C. for 4 hours. A precipitation operation, a washing operation, and a reduced-pressure drying operation were performed in the same manner as described above to obtain a polyimide (PI-1) having a degree of imidization of 65%. The polyimide (PI-1) was dissolved in NMP so that the solid content was 10 wt %.

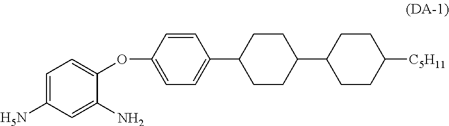

### Preparation of Liquid Crystal Composition

### (1) Preparation of Positive-Type Liquid Crystal (LC1)

The compounds respectively represented by the following formulas (LC1-1) to (LC1-4) were mixed in the ratio (weight ratio) shown in Table 1 to prepare a positive-type liquid crystal (LC1).

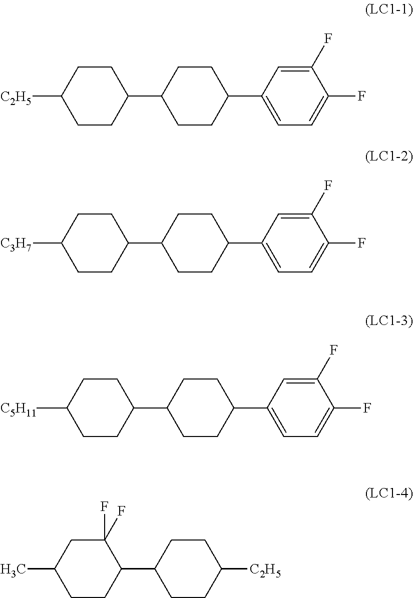

TABLE 1

| Compound | Weight ratio |
|---|---|
| LC1-1 | 30 |
| LC1-2 | 30 |
| LC1-3 | 30 |
| LC1-4 | 10 |

### (2) Preparation of Negative-Type Liquid Crystal (LC2)

The compounds respectively represented by the following formulas (LC2-1) to (LC2-4) were mixed in the ratio (weight ratio) shown in Table 2 to prepare a negative-type liquid crystal (LC2).

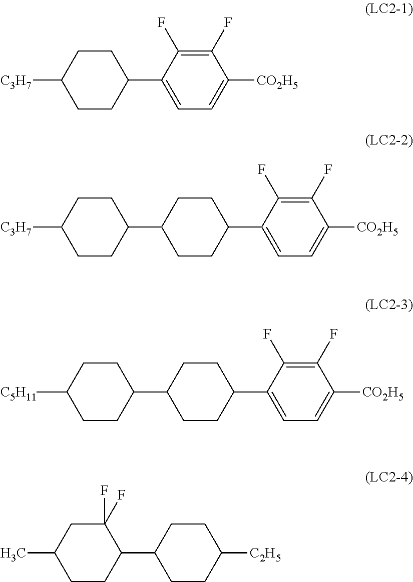

TABLE 2

| Compound | Weight ratio |
|---|---|
| LC2-1 | 30 |
| LC2-2 | 30 |
| LC2-3 | 30 |
| LC2-4 | 10 |

### Example 1

### Preparation of Liquid Crystal Aligning Agent

NMP (organic solvent) and butyl cellosolve (BC) (organic solvent) were added to the solution of the polyamic acid (PA-1) (polymer (A)) obtained in Synthesis Example 1 to prepare a solution (NMP:BC=50:50 (weight ratio)) having a solid content of 3.5 wt %. The solution was filtered through a filter having a pore size of 0.5 μm to prepare a liquid crystal aligning agent (E−1).

### Production of Liquid Crystal Display

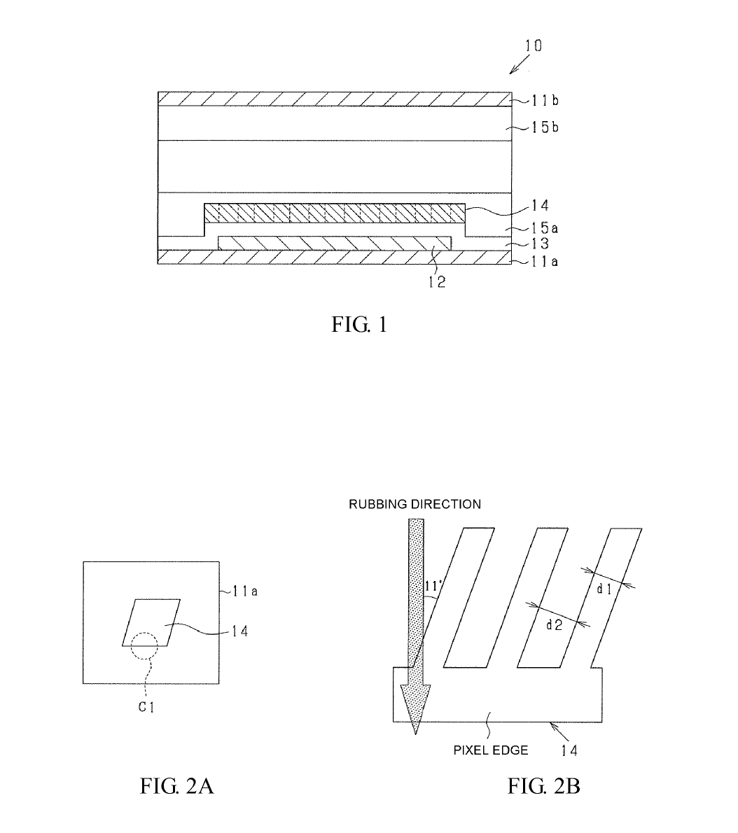

An FFS-mode liquid crystal display illustrated in FIG. 1 was produced. Specifically, a glass substrate 11a on which an unpatterned bottom electrode 12, a silicon nitride film 13 (insulating layer), and a top electrode 14 (a pair of electrodes having a comb-like pattern) were sequentially stacked, and a common glass substrate 11b on which an electrode was not formed, were provided. The liquid crystal aligning agent prepared as described above was applied to the surface of the glass substrate 11a (on which the electrodes were formed) and the surface of the common glass substrate 11b using a spinner to form a film. Each film was prebaked on a hot plate (80° C.) for 1 minute, and post-baked at 230° C. for 15 minutes in an oven (of which the internal atmosphere was replaced with nitrogen) to obtain a film having an average thickness of 10001. FIGS. 2A and 2B are schematic plan views illustrating the top electrode 14. FIG. 2A is a top view illustrating the top electrode 14, and FIG. 2B is an enlarged view of the area C1 in FIG. 2A that is enclosed by the broken line. The top electrode 14 had a configuration in which the line width d1 of the transparent electrode was 4 μm, and the electrode-to-electrode distance d2 was 6 μm.

The surface of the film formed on each glass substrate was subjected to a rubbing treatment using cotton to obtain liquid crystal alignment films 15a and 15b. The substrates 11a and 11b were bonded through a spacer having a diameter of 3.5 μm so that the rubbing directions of the substrates 11a and 11b were antiparallel to prepare an empty cell that was not filled with a liquid crystal. The positive-type liquid crystal (LC1) was then injected into the cell. A polarizer was bonded to each substrate so that the polarization directions of the polarizers were orthogonal to each other to produce a liquid crystal display.

### Evaluation of Liquid Crystal Alignment Capability

The presence or absence of an abnormal domain (i.e., an abnormal change in brightness) in the liquid crystal display when an AC voltage of 5 V was tuned ON/OFF (applied/removed) was observed using a microscope at a magnification of 50. The liquid crystal alignment capability was evaluated as “Acceptable” when an abnormal domain was not observed, and was evaluated as “Unacceptable” when an abnormal domain was observed. The liquid crystal alignment capability of the above liquid crystal display was evaluated as “Acceptable”.

### Example 2

A liquid crystal aligning agent was prepared, and a liquid crystal display was produced in the same manner as in Example 1, except that the polyamic acid (PA-2) was used instead of the polyamic acid (PA-1). The liquid crystal alignment capability of the resulting liquid crystal display was evaluated as “Acceptable”.

### Example 3

A liquid crystal aligning agent was prepared, and a liquid crystal display was produced in the same manner as in Example 1, except that the polyamic acid (PA-3) was used instead of the polyamic acid (PA-1). The liquid crystal alignment capability of the resulting liquid crystal display was evaluated as “Acceptable”.

### Example 4

### Preparation of Liquid Crystal Aligning Agent

NMP (organic solvent) and butyl cellosolve (BC) (organic solvent) were added to the solution of the polyimide (PI-1) (polymer (A)) obtained in Synthesis Example 5 to prepare a solution (NMP:BC=50:50 (weight ratio)) having a solid content of 6.0 wt %. The solution was filtered through a filter having a pore size of 0.5 μm to prepare a liquid crystal aligning agent (E-2).

### Production of VA-Mode Liquid Crystal Display

The liquid crystal aligning agent (E-2) prepared as described above was applied to the surface of a transparent electrode (ITO film) formed on a glass substrate (thickness: 1 mm) using a liquid crystal alignment film printer (manufactured by Nissha Printing Co., Ltd.). The liquid crystal aligning agent was prebaked on a hot plate (80° C.) for 1 minute, and post-baked on a hot plate (200° C.) for 60 minutes to obtain a film (liquid crystal alignment film) having an average thickness of 800 Å. The above operation was repeated to obtain a pair of glass substrates (two glass substrates) on which the liquid crystal alignment film and the transparent conductive film were sequentially formed.

An epoxy resin adhesive including aluminum oxide balls having a diameter of 5.5 μm was applied to the outer edge of the surface of one of the pair of substrates (on which the liquid crystal alignment film was formed), and the pair of substrates were placed one on top of another so that the liquid crystal alignment films faced each other, and compression-bonded to cure the adhesive. The negative-type liquid crystal (LC2) prepared as described above was injected into the space between the pair of substrates through a liquid crystal injection port, and the liquid crystal injection port was sealed using an acrylic photocurable adhesive to produce a VA-mode liquid crystal display.

### Evaluation of Liquid Crystal Alignment Capability

The liquid crystal alignment capability of the liquid crystal display produced as described above was evaluated in the same manner as in Example 1 (see “Evaluation of liquid crystal alignment capability”). Since an abnormal domain was not observed, the liquid crystal display was evaluated as “Acceptable”.

### Example 5

A liquid crystal aligning agent was prepared, and a liquid crystal display was produced in the same manner as in Example 4, except that the polyamic acid (PA-4) was used instead of the polyamic acid (PI-1). The liquid crystal alignment capability of the resulting liquid crystal display was evaluated as “Acceptable”.

The liquid crystal display according to the embodiments of the present invention implements a high response speed and an excellent liquid crystal alignment capability.

Obviously, numerous modifications and variations of the invention are possible in light of the above teachings. It is therefore to be understood that within the scope of the appended claims, the invention may be practiced otherwise than as specifically described herein.

What is claimed is:

1. A liquid crystal display comprising:
a liquid crystal layer including a liquid crystal composition that includes a cyclohexane compound represented by a formula (1); and
a liquid crystal alignment film provided using a liquid crystal aligning agent that includes a polymer which is a polyamic acid, a polyimide, a polyamic ester, or a combination thereof, 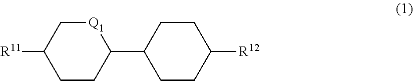
wherein
R¹¹ and R¹² are each independently a monovalent chain hydrocarbon group, or a group obtained by substituting —CH₂— included in the chain hydrocarbon group with —O—, —CO—, or —COO—, wherein at least one hydrogen atom included in R¹¹ and R¹² is optionally substituted with a halogen atom or a cyano group, and
Q¹ is a divalent group represented by a formula (1-1), a divalent group represented by a formula (1-2), or a divalent group represented by a formula (1-3), 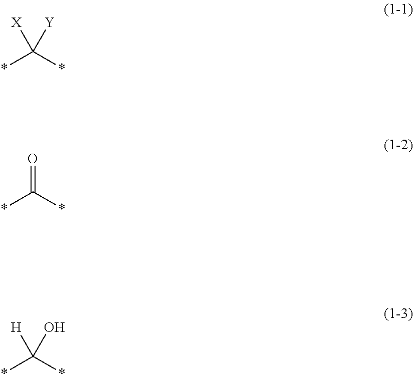
wherein
X is a hydrogen atom or a halogen atom,
Y is a halogen atom, wherein X and Y are either identical or different when X is a halogen atom, and
* is a bonding position.

2. The liquid crystal display according to claim 1, wherein the polymer is obtained by reacting a tetracarboxylic dianhydride with a diamine that includes a compound represented by a formula (d−1), a compound represented by a formula (d-2), a compound represented by a formula (d-3), a compound represented by a formula (d-4), or a combination thereof, 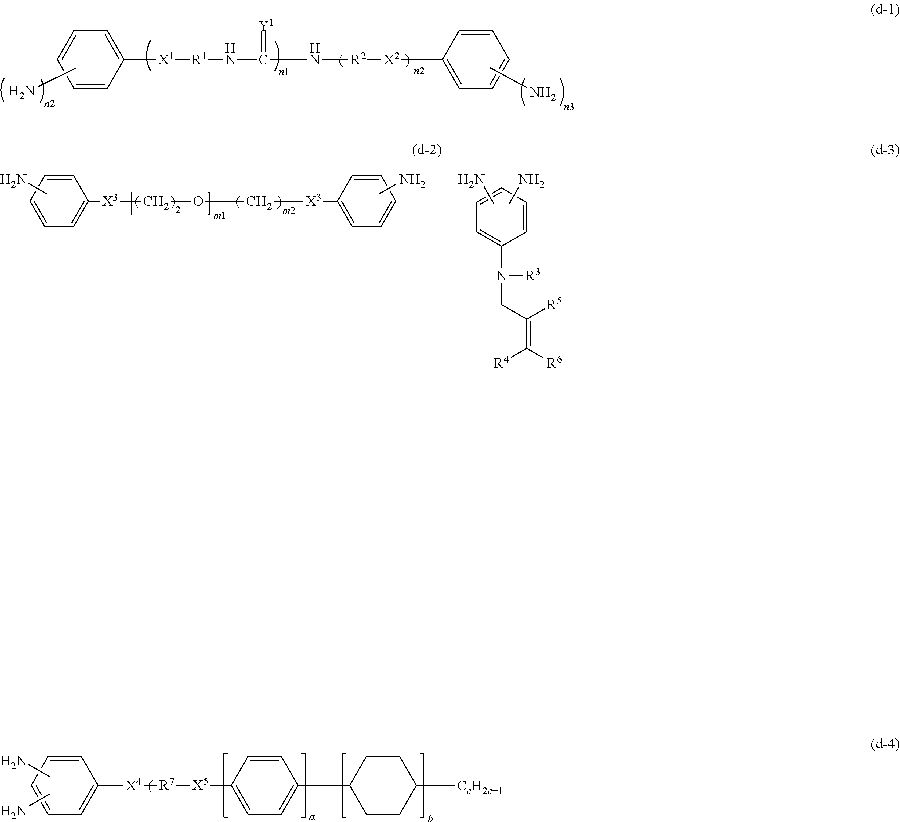
wherein
X¹ and X² are each independently a single bond, —O—, —S—, —OCO—, or —COO—,
Y¹ is an oxygen atom or a sulfur atom,
R¹ and R² are each independently an alkanediyl group having 1 to 3 carbon atoms,
n1 is 0 or 1,
n2 and n3 are integers that satisfy n2+n3=2 when n1 is 0, and each of n2 and n3 is 1 when n1 is 1,
each X³ is independently a single bond, —O—, or —S—, wherein two X³ are either identical or different,
m1 is an integer from 0 to 3,
m2 is an integer from 1 to 12 when m1 is 0, and m2 is 2 when m1 is an integer from 1 to 3,
R³ is a linear or branched monovalent hydrocarbon group having 1 to 12 carbon atoms,
R⁴ is a hydrogen atom or a linear or branched monovalent hydrocarbon group having 1 to 12 carbon atoms,
R⁵ and R⁶ are each independently a hydrogen atom or a methyl group,
X⁴ and X⁵ are each independently a single bond, —O—, —OCO—, or —OCO—,
R⁷ is an alkanediyl group having 1 to 3 carbon atoms,
a is 0 or 1,
b is an integer from 0 to 2, wherein a case where a=b=0 is excluded,
c is an integer from 1 to 20, and
k is 0 or 1.

3. The liquid crystal display according to claim 1, wherein the liquid crystal composition further includes a compound represented by a formula (2), a compound represented by a formula (3), a compound represented by a formula (4), or a combination thereof, 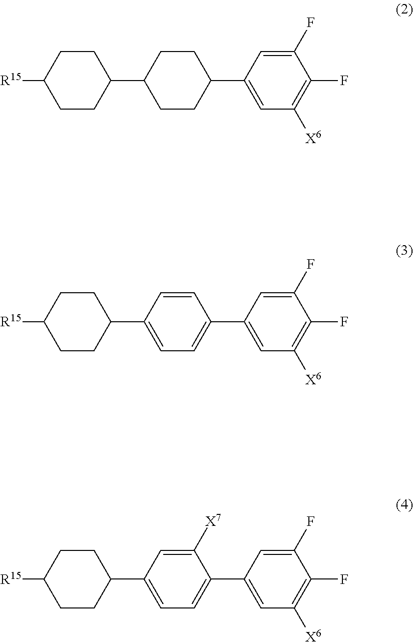
wherein
R¹⁵ is an alkyl group, and
X⁶ and X⁷ are each independently a hydrogen atom or a fluorine atom.

4. The liquid crystal display according to claim 1, wherein the liquid crystal composition further includes a compound represented by a formula (6), a compound represented by a formula (7), a compound represented by a formula (8), or a combination thereof, 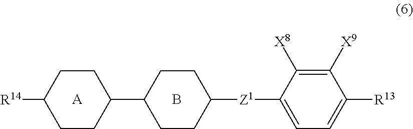
wherein
R¹³ and R¹⁴ are each independently an alkyl group having 1 to 12 carbon atoms, an alkoxy group having 1 to 12 carbon atoms, an alkenyl group having 2 to 12 carbon atoms, or an alkenyloxy group having 2 to 11 carbon atoms, wherein a hydrogen atom included in R¹³ and R¹⁴ is optionally substituted with a fluorine atom,
A and B are each independently a 1,4-cyclohexylene group or a 1,4-phenylene group,
X⁸ and X⁹ are each independently a fluorine atom or a chlorine atom, and
Z¹ is a methyleneoxy group, a carbonyloxy group, an ethylene group, or a single bond, 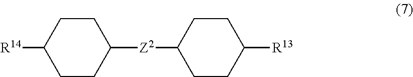
wherein
Z² is a single bond or an ethylene group, and
R¹³ and R¹⁴ are as defined in the formula (6), 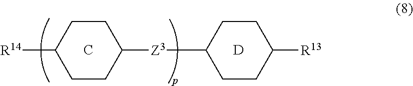
wherein
p is an integer from 1 to 3,
C and D are each independently a 1,4-cyclohexylene group, a 1,4-phenylene group, a 2-fluoro-1,4-phenylene group, or a 3-fluoro-1,4-phenylene group, wherein D is a 1,4-phenylene group when p is 1,
Z³ is a single bond, an ethylene group, a methyleneoxy group, or a carbonyloxy group, wherein a plurality of C are either identical or different and a plurality of Z³ are either identical or different when p is 2 or 3, and
R¹³ and R¹⁴ are as defined in the formula (6).

5. A method for producing a liquid crystal display, comprising:
applying a liquid crystal aligning agent to a surface of each of a pair of substrates, the liquid crystal aligning agent including a polymer which is a polyamic acid, a polyimide, a polyamic ester, or a combination thereof;
heating the liquid crystal aligning agent to form a film; and
disposing the pair of substrates so that the films formed on the pair of substrates face each other through a liquid crystal layer to provide a liquid crystal cell, the liquid crystal layer including a liquid crystal composition which includes a cyclohexane compound represented by a formula (1), 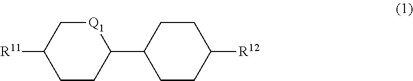
wherein
R¹¹ and R¹² are each independently a monovalent chain hydrocarbon group, or a group obtained by substituting —CH₂— included in the chain hydrocarbon group with —O—, —CO—, or —COO—, wherein at least one hydrogen atom included in R¹¹ and R¹² is optionally substituted with a halogen atom or a cyano group, and
Q is a divalent group represented by a formula (1-1), a divalent group represented by a formula (1-2), or a divalent group represented by a formula (1-3), 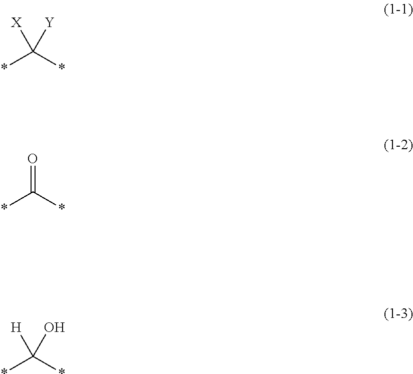
wherein
X is a hydrogen atom or a halogen atom,
Y is a halogen atom, wherein X and Y are either identical or different when X is a halogen atom, and
* is a bonding position.
